(19) United States
(12) Patent Application Publication
(10) Pub. No.: US 2024/0037034 A1
(43) Pub. Date: Feb. 1, 2024

(54) DATA INTAKE BUFFERS FOR DEDUPLICATION STORAGE SYSTEM

(71) Applicant: HEWLETT PACKARD ENTERPRISE DEVELOPMENT LP, Houston, TX (US)

(72) Inventors: David Malcolm Falkinder, Bristol (GB); Richard Phillip Mayo, Bristol (GB)

(21) Appl. No.: 17/816,016

(22) Filed: Jul. 29, 2022

(51) Int. Cl. G06F 12/0806; G06F 3/06

(52) U.S. Cl. CPC G06F 12/0806; G06F 3/0608; G06F 3/0644; G06F 3/0673; G06F 2212/1044

(57) ABSTRACT

Example implementations relate to data storage. An example includes a method comprising: receiving a data stream to be stored in a persistent storage of a deduplication storage system; assigning new data units to container indexes; storing the new data units of the data stream in a plurality of intake buffers, where each new data unit is stored in the intake buffer associated with the container index it is assigned to; determining whether a cumulative amount stored in the plurality of intake buffers exceeds a first threshold; in response to a determination that the cumulative amount exceeds the first threshold, determining a least recently updated intake buffer of the plurality of intake buffers; generating a first container entity group object comprising a set of data units stored in the least recently updated intake buffer; and writing the first container entity group object from memory to the persistent storage.

### BACKGROUND

Data reduction techniques can be applied to reduce the amount of data stored in a storage system. An example data reduction technique includes data deduplication. Data deduplication identifies data units that are duplicative, and seeks to reduce or eliminate the number of instances of duplicative data units that are stored in the storage system.

### BRIEF DESCRIPTION OF THE DRAWINGS

Some implementations are described with respect to the following figures.

FIG. 1 is a schematic diagram of an example system, in accordance with some implementations.

FIG. 2 is an illustration of example data structures, in accordance with some implementations.

FIG. 3 is an illustration of an example process, in accordance with some implementations.

FIGS. 4A-4J are illustrations of example operations, in accordance with some implementations.

FIG. 5 is an illustration of an example process, in accordance with some implementations.

FIG. 6 is a diagram of an example machine-readable medium storing instructions in accordance with some implementations.

FIG. 7 is a schematic diagram of an example computing device, in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a storage system may back up a collection of data (referred to herein as a “stream” of data or a “data stream”) in deduplicated form, thereby reducing the amount of storage space required to store the data stream. The storage system may create a “backup item” to represent a data stream in a deduplicated form. A data stream (and the backup item that represents it) may correspond to user object(s) (e.g., file(s), a file system, volume(s), or any other suitable collection of data). For example, the storage system may perform a deduplication process including breaking a data stream into discrete data units (or “chunks”) and determining “fingerprints” (described below) for these incoming data units. Further, the storage system may compare the fingerprints of incoming data units to fingerprints of stored data units, and may thereby determine which incoming data units are duplicates of previously stored data units (e.g., when the comparison indicates matching fingerprints). In the case of data units that are duplicates, the storage system may store references to previously stored data units instead of storing the duplicate incoming data units. In this manner, the deduplication process may reduce the amount of space required to store the received data stream.

As used herein, the term “fingerprint” refers to a value derived by applying a function on the content of the data unit (where the “content” can include the entirety or a subset of the content of the data unit). An example of a function that can be applied includes a hash function that produces a hash value based on the content of an incoming data unit. Examples of hash functions include cryptographic hash functions such as the Secure Hash Algorithm 2 (SHA-2) hash functions, e.g., SHA-224, SHA-256, SHA-384, etc. In other examples, other types of hash functions or other types of fingerprint functions may be employed.

A “storage system” can include a storage device or an array of storage devices. A storage system may also include storage controller(s) that manage(s) access of the storage device(s). A “data unit” can refer to any portion of data that can be separately identified in the storage system. In some cases, a data unit can refer to a chunk, a collection of chunks, or any other portion of data. In some examples, a storage system may store data units in persistent storage. Persistent storage can be implemented using one or more of persistent (e.g., nonvolatile) storage device(s), such as disk-based storage device(s) (e.g., hard disk drive(s) (HDDs)), solid state device(s) (SSDs) such as flash storage device(s), or the like, or a combination thereof.

A “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

In some examples, a storage system may use stored metadata for processing and reconstructing an original data stream from the stored data units. This stored metadata may include data recipes (also referred to herein as “manifests”) that specify the order in which particular data units were received (e.g., in a data stream). As used herein, the term “stream location” may refer to the location of a data unit in a data stream.

In order to retrieve the stored data (e.g., in response to a read request), the storage system may use a manifest to determine the received order of data units, and thereby recreate the original data stream. The manifest may include a sequence of records, with each record representing a particular set of data unit(s). The records of the manifest may include one or more fields (also referred to herein as “pointer information”) that identify container indexes. As used herein, a “container index” is a data structure containing metadata for a plurality of stored data units. For example, such metadata may include one or more index fields that specify location information (e.g., containers, offsets, etc.) for the stored data units, compression and/or encryption characteristics of the stored data units, and so forth.

In some examples, a deduplication storage system may store the data units in container data objects included in a remote storage (e.g., a “cloud” or network storage service), rather than in a local filesystem. Subsequently, the data stream may be updated to include new data units (e.g., during a backup process) at different locations in the data stream. New data units may be appended to existing container data objects (referred to as “data updates”). Such appending may involve performing a “get” operation to retrieve a container data object, loading and processing the container data object in memory, and then performing a “put” operation to transfer the updated container data object from memory to the remote storage.

However, in many examples, the size of the data update (e.g., 1 MB) may be significantly smaller than the size of the container data object (e.g., 100 MB). Accordingly, the aforementioned process including transferring and processing the container data object may involve a significant amount of wasted bandwidth, processing time, and so forth. Therefore, in some examples, each data update may be stored as a separate object (referred to herein as a “container entity group”) in the remote storage, instead of being appended to a larger container data object. However, in many examples, the data updates may correspond to many locations spread throughout the data stream. Accordingly, writing the container entity groups to the remote storage may involve a relatively large number of transfer operations, with each transfer operation involving a relatively small data update. Further, in some examples, the use of a remote storage service may incur financial charges that are based on the number of individual transfers. Therefore, storing data updates individually in a remote storage service may result in significant costs.

In accordance with some implementations of the present disclosure, a deduplication storage system may store incoming data updates in a set of intake buffers in memory. Each intake buffer may store data updates associated with a particular container index. However, in some examples, the deduplication storage system may not have enough memory to maintain a separate intake buffer for each container index used for the data stream. Accordingly, in some implementations, the deduplication storage system may limit the maximum number of intake buffers that can be used at the same time.

In some implementations, the deduplication storage system may determine an order of the intake buffers according to their respective elapsed times since last update (i.e., last addition of new data). For example, the deduplication storage system may determine the order of the intake buffers from the most recently updated intake buffer to the least recently updated intake buffer.

In some implementations, the deduplication storage system may periodically determine the amount of data stored in the intake buffers, and may determine whether any of these stored amounts exceeds an individual threshold. As used herein, the “stored amount” of an intake buffer refers to the cumulative size of the data updates stored in the intake buffer. Further, as used herein, an “individual threshold” may be a threshold level specified for each intake buffer. Upon determining that the stored amount of an intake buffer exceeds the individual threshold, the deduplication storage system may transfer the data updates stored in that intake buffer to the remote storage as a single container entity group (“CEG”) object. This transfer of data updates from an intake buffer to the remote storage may be referred to herein as an “eviction” of the intake buffer.

In some implementations, the deduplication storage system may periodically determine the cumulative amount of data stored in the intake buffers, and may determine whether the cumulative amount exceeds a total threshold. As used herein, the “cumulative amount” may refer to the sum of the stored amounts of the intake buffers. Further, as used herein, a “total threshold” may be a threshold level specified for the cumulative amount for the intake buffers. Upon determining that the cumulative amount exceeds the total threshold, the deduplication storage system may determine the least recently updated intake buffer, and may then evict the least recently updated intake buffer (i.e., by transferring a CEG object to the remote storage).

In some implementations, the maximum number of intake buffers, the individual threshold, and the total threshold may be settings or parameters that may be adjusted to control the performance and efficiency of the intake buffers. For example, increasing the maximum number of intake buffers may increase the number of data stream locations for which data updates are buffered, but may also increase the amount of memory required to store the intake buffers. In another example, increasing the individual threshold may result in less frequent generation of CEG objects, and may increase the average size of the CEG objects. In yet another example, decreasing the total threshold may result in more frequent generation of CEG objects, and may reduce the average size of the CEG objects. Accordingly, the number and size of transfers to remote storage may be controlled by adjusting one or more of the maximum number of intake buffers, the individual threshold, and the total threshold. In this manner, the financial cost associated with the transfers to remote storage may be reduced or optimized.

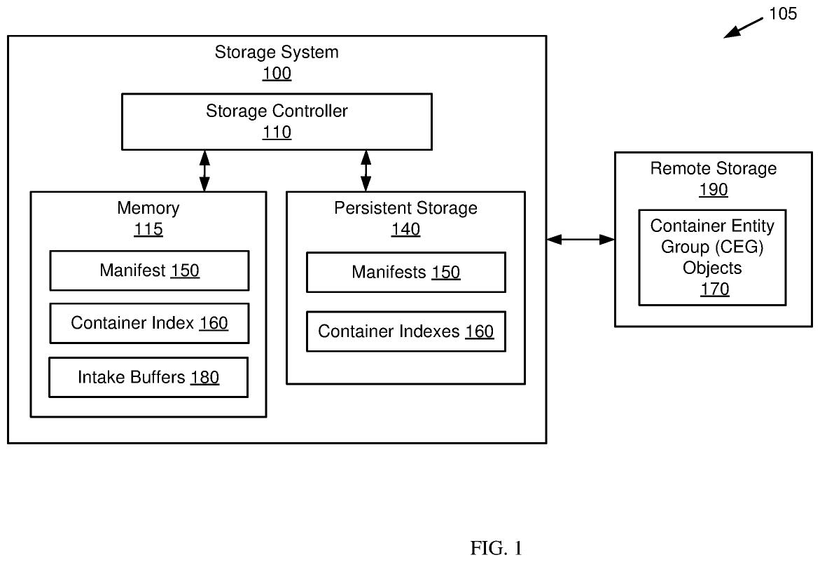

### FIG. 1—Example System

FIG. 1 shows an example system 105 that includes a storage system 100 and a remote storage 190. The storage system 100 may include a storage controller 110, memory 115, and persistent storage 140, in accordance with some implementations. The storage system 100 may be coupled to the remote storage 190 via a network connection. The remote storage 190 may be a network-based persistent storage facility or service (also referred to herein as “cloud-based storage”). In some examples, use of the remote storage 190 may incur financial charges that are based on the number of individual transfers.

The persistent storage 140 may include one or more non-transitory storage media such as hard disk drives (HDDs), solid state drives (SSDs), optical disks, and so forth, or a combination thereof. The memory 115 may be implemented in semiconductor memory such as random access memory (RAM). In some examples, the storage controller 110 may be implemented via hardware (e.g., electronic circuitry) or a combination of hardware and programming (e.g., comprising at least one processor and instructions executable by the at least one processor and stored on at least one machine-readable storage medium). In some implementations, the memory 115 may include manifests 150, container indexes 160, and intake buffers 180. Further, the persistent storage 140 may store manifests 150, and container indexes 160. The remote storage 190 may store container entity group (CEG) objects 170.

In some implementations, the storage system 100 may perform deduplication of the stored data. For example, the storage controller 110 may divide a stream of input data into data units, and may include at least one copy of each data unit in at least one of the CEG objects 170. Further, the storage controller 110 may generate a manifest 150 to record the order in which the data units were received in the data stream. The manifest 150 may include a pointer or other information indicating the container index 160 that is associated with each data unit. For example, the metadata in the container index 160 may including a fingerprint (e.g., a hash) of a stored data unit for use in a matching process of a deduplication process. Further, the metadata in the container index 160 may include a reference count of a data unit (e.g., indicating the number of manifests 150 that reference each data unit) for use in housekeeping (e.g., to determine whether to delete a stored data unit). Furthermore, the metadata in the container index 160 may include identifiers for the storage locations of data units for use in reconstruction of deduplicated data. In an example, for each data unit referenced by the container index 160, the container index 160 may include metadata identifying the CEG object 170 that stores the data unit, and the location (within the CEG object 170) that stores the data unit.

In some implementations, the storage controller 110 may receive a read request to access the stored data, and in response may access the manifest 150 to determine the sequence of data units that made up the original data. The storage controller 110 may then use pointer data included in the manifest 150 to identify the container indexes 160 associated with the data units. Further, the storage controller 110 may use information included in the identified container indexes 160 to determine the locations that store the data units (e.g., for each data unit, a respective CEG objects 170, offset, etc.), and may then read the data units from the determined locations.

In one or more implementations, the storage controller 110 may perform a deduplication matching process, which may include generating a fingerprint for each data unit. For example, the fingerprint may include a full or partial hash value based on the data unit. To determine whether an incoming data unit is a duplicate of a stored data unit, the storage controller 110 may compare the fingerprint generated for the incoming data unit to fingerprints of stored data units (i.e., fingerprints included in a container index 160). If this comparison of fingerprints results in a match, the storage controller 110 may determine that a duplicate of the incoming data unit is already stored by the storage system 100, and therefore will not again store the incoming data unit. Otherwise, if the comparison of fingerprints does not result in a match, the storage controller 110 may determine that the incoming data unit is not a duplicate of data that is already stored by the storage system 100, and therefore will store the incoming data unit as new data.

In some implementations, the fingerprint of the incoming data unit may be compared to fingerprints included in a particular set of container indexes 160 (referred to herein as a “candidate list” of container indexes 160). In some implementations, the candidate list may be generated using a data structure (referred to herein as a “sparse index”) that maps particular fingerprints (referred to herein as “hook points”) to corresponding container indexes 160. For example, the hook points of incoming data units may be compared to the hook points in the sparse index, and each matching hook point may identify (i.e., is mapped to) a container index 160 to be included in the candidate list.

In some implementations, incoming data units that are identified as new data units (i.e., having fingerprints that do not match the stored fingerprints in the container indexes 160) may be temporarily stored in the intake buffers 180. Each intake buffer 180 may be associated with a different container index 160. For each new data unit, the storage controller 110 may assign the new data unit to a container index 160, and may then store the new data unit in the intake buffer 180 corresponding to the assigned container index 160.

In some implementations, during the deduplication matching process, the storage controller 110 may assign a new data unit to a particular container index 160 based on the number of proximate data units (i.e., other data units that are proximate to the new data unit within the received data stream) that match to that particular container index 160. Stated differently, a new data unit may be assigned to the container index that has the largest match proximity to the new data unit. As used herein, the “match proximity” from a container index to a new data unit refers to the total number of data units that are proximate to the new data unit (within the data stream), and that also have fingerprints that match the stored fingerprints in that container index.

For example, the storage controller 110 may generate fingerprints for data units in a data stream, and may attempt to match these fingerprints to the fingerprints included in two container indexes 160 included in a candidate list. In this example, the storage controller 110 determines that the fingerprint of a first data unit does not match the fingerprints in the two container indexes 160, and therefore the first data unit is a new data unit to be stored in the storage system 100. The storage controller 110 determines that the new data unit is preceded (in the data stream) by ten data units that match to the first container index 160, and is followed (in the data stream) by four data units that match to the second container index 160. Therefore, in this example, the match proximity (i.e., ten) of the first container index 160 to the new data unit is larger than the match proximity (i.e., four) of the second container index 160 to the new data unit, Therefore, the storage controller 110 assigns the new data unit to the first container index 160 (which has the larger match proximity to the new data unit). Further, in this example, the storage controller 110 stores the new data unit in the intake buffer 180 that corresponds to the first container index 160 assigned to the new data unit.

In some implementations, the determination of whether data units are proximate may be defined by configuration settings of the storage system 100. For example, determining whether data units are proximate may be specified in terms of distance (e.g., two data units are proximate if they are not separated by more than a maximum number of intervening data units). In another example, determining whether data unit are proximate may be specified in terms of size(s) of unit blocks (e.g., the maximum separation can increase as the size of a proximate block of data units increases, as the number of blocks increases, and so forth). Other implementations are possible.

In some implementations, the quantity of intake buffers 180 included in memory 115 may be limited to a maximum number (e.g., by a configuration setting). As such, the intake buffers 180 loaded in memory 115 may only correspond to a subset of the container indexes 160 that include metadata for the data stream. Accordingly, in some examples, at least one of the container indexes 160 may not have a corresponding intake buffer 180 loaded in the memory.

In some implementations, the storage controller 110 may determine the order of the intake buffers 180 according to recency of update of each intake buffer 180. For example, the storage controller 110 may track the last time that each intake buffer 180 was updated (i.e., received new data), and may use this information to determine the order of the intake buffers 180 from most recently updated to least recently updated. In some implementations, the recency order of the intake buffers 180 may be tracked using a data structure (e.g., a table listing the intake buffers 180 in the current order), using a metadata field of each intake buffer 180 (e.g., an order number), and so forth.

In some implementations, an intake buffer 180 may be evicted to form a CEG object 170 (i.e., by collecting the data units stored in the intake buffer 180). In some implementations, one or more intake buffers 180 may be evicted in response to a detection of an eviction trigger event. For example, the storage controller 110 may determine that the stored amount of a given intake buffer 180 exceeds an individual threshold, and in response may evict that intake buffer 180. In another example, the storage controller 110 may determine that the cumulative amount of the intake buffers 180 exceeds a total threshold, and in response may evict the least recently updated intake buffer 180. In yet another example, the storage controller 110 may detect an event that causes data in memory 115 to be persisted (e.g., a user or application command to flush the memory 115), and in response may evict all of the intake buffers 180.

In some implementations, the maximum number of intake buffers 180, the individual threshold, and the total threshold may be settings or parameters that may be adjusted to control the number and size of data transfers to remote storage 190. In this manner, the financial cost associated with the transfers to remote storage may be reduced or optimized.

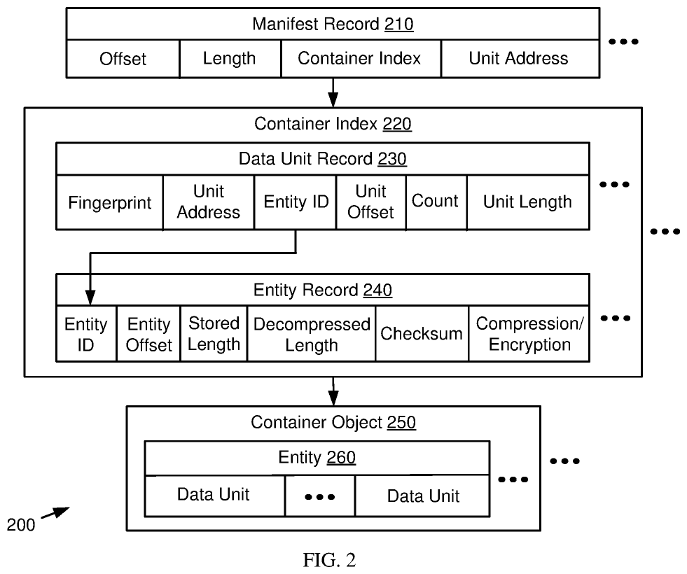

### FIG. 2—Example Data Structures

FIG. 2 shows an illustration of example data structures 200 used in deduplication, in accordance with some implementations. As shown, the data structures 200 may include a manifest record 210, a container index 220, and a container object 250. In some examples, the manifest record 210, the container index 220, and the container object 250 may correspond generally to example implementations of a manifest 150, a container index 160, and container entity group (CEG) object 170 (shown in FIG. 1), respectively. In some examples, the data structures 200 may be generated and/or managed by the storage controller 110 (shown in FIG. 1).

As shown in FIG. 2, in some examples, the manifest record 210 may include various fields, such as offset, length, container index, and unit address. In some implementations, each container index 220 may include any number of data unit record(s) 230 and entity record(s) 240. Each data unit record 230 may include various fields, such as a fingerprint (e.g., a hash of the data unit), a unit address, an entity identifier, a unit offset (i.e., an offset of the data unit within the entity), a reference count value, and a unit length. In some examples, the reference count value may indicate the number of manifest records 210 that reference the data unit record 230. Further, each entity record 240 may include various fields, such as an entity identifier, an entity offset (i.e., an offset of the entity within the container), a stored length (i.e., a length of the data unit within the entity), a decompressed length, a checksum value, and compression/encryption information (e.g., type of compression, type of encryption, and so forth). In some implementations, each container object 250 may include any number of entities 260, and each entity 260 may include any number of stored data units.

In one or more implementations, the data structures 200 may be used to retrieve stored deduplicated data. For example, a read request may specify an offset and length of data in a given file. These request parameters may be matched to the offset and length fields of a particular manifest record 210. The container index and unit address of the particular manifest record 210 may then be matched to a particular data unit record 230 included in a container index 220. Further, the entity identifier of the particular data unit record 230 may be matched to the entity identifier of a particular entity record 240. Furthermore, one or more other fields of the particular entity record 240 (e.g., the entity offset, the stored length, checksum, etc.) may be used to identify the container object 250 and entity 260, and the data unit may then be read from the identified container object 250 and entity 260.

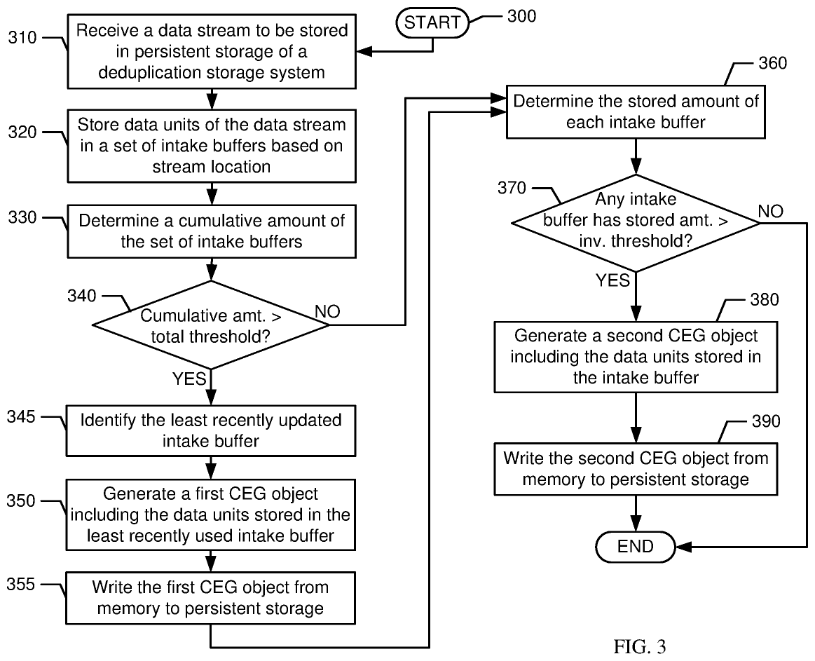

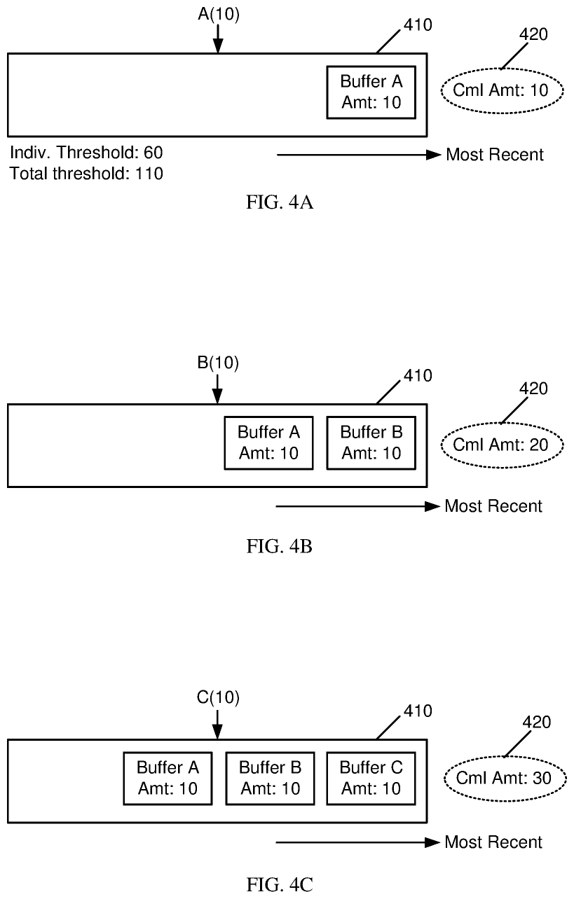

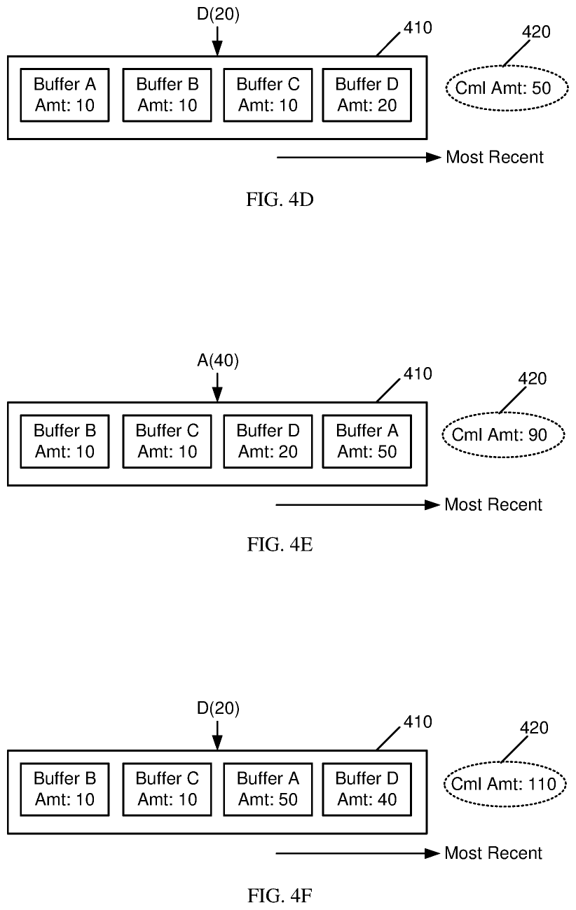

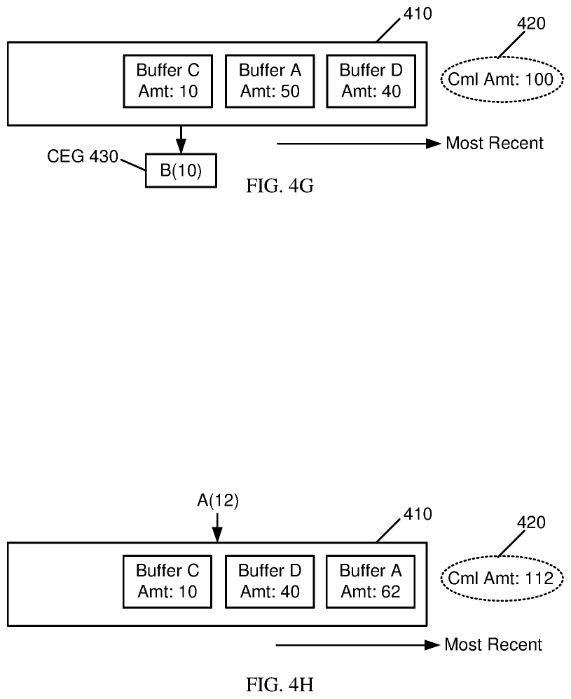

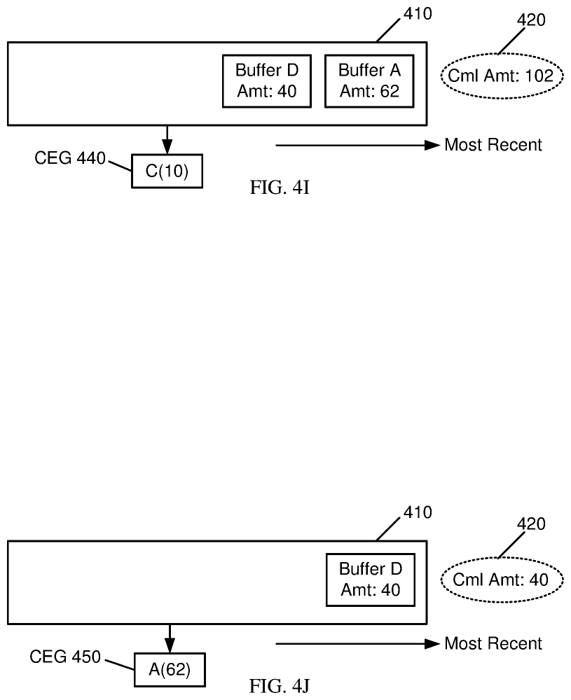

### FIGS. 3 and 4A-4J—Example Process for Storing Data

FIG. 3 shows an example process 300 for storing data, in accordance with some implementations. The process 300 may be performed by a controller executing instructions (e.g., storage controller 110 shown in FIG. 1). The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. For the sake of illustration, details of the process 300 are described below with reference to FIGS. 4A-4J, which show example operations in accordance with some implementations. However, other implementations are also possible.

In FIGS. 4A-4J, a rectangle 410 illustrates the set of intake buffers that are loaded in memory at a given point in time. The intake buffers are illustrated as boxes inside the rectangle 410, and are ordered (from right to left) according to how recently each intake buffer was updated (e.g., from most recently updated to least recently updated). Further, the ellipse 420 illustrates the cumulative amounts of the intake journals in memory (i.e., the intake journals shown inside the rectangle 410). Furthermore, a receipt of new data units to be stored in an intake journal is illustrated by an inbound arrow that points to the box 410, where the inbound arrow is labelled to indicate the number of data units received, and the container index associated with the received data units. For example, the label “A(10)” indicates ten data units associated with container index A. Additionally, in FIGS. 4A-4J, the individual threshold is 60 data units, the total threshold is 100 data units, and the maximum number of intake buffers is four (illustrated by the number of spaces in the rectangle 410). It is noted that the order of the intake buffers inside the rectangle 410 (as shown in FIGS. 4A-4J) is intended to illustrate the changes to the recency order of the intake buffers at different points in time, but is not intended to limit the locations of the intake buffers in memory. For example, it is contemplated that the recency order of the intake buffers may be tracked using a data structure, metadata, and the like. Further, the locations of the intake buffers in memory may not change based on the recency order of the intake buffers.

Referring now to FIG. 3, block 310 may include receiving a data stream to be stored in persistent storage of deduplication storage system. Block 320 may include storing data units of the data stream in a set of intake buffers based on the stream location of the data units. Block 330 may include determining a cumulative amount of the set of intake buffers.

For example, referring to FIG. 4A, the inbound arrow A(10) indicates a receipt of 10 data units that are associated with container index A. The received data units are stored in the intake buffer (labelled “Buffer A” in FIG. 4A) associated with container index A. Accordingly, as shown in FIG. 4A, the Buffer A includes ten data units (as illustrated by the label “Amt: 10” in Buffer A). Further, the cumulative amount is 10 data units (as illustrated by the label “Cml Amt: 10” in ellipse 420).

Referring now to FIG. 4B, the inbound arrow B(10) indicates a receipt of 10 data units associated with container index B. Accordingly, the received data units are stored in Buffer B, which is shown in the rightmost position inside the rectangle 410 (indicating that Buffer B is the most recently updated intake buffer). Further, the cumulative amount is equal to 20 data units.

Referring now to FIG. 4C, the inbound arrow C(10) indicates a receipt of 10 data units associated with container index C. Accordingly, the received data units are stored in Buffer C. Further, the cumulative amount is equal to 30 units.

Referring now to FIG. 4D, the inbound arrow D(20) indicates a receipt of 20 data units associated with container index D. Accordingly, the received data units are stored in Buffer D. Further, the cumulative amount is equal to 50 data units. As shown in FIG. 4D, the rectangle 410 does not have any empty spaces, thereby illustrating that the maximum number of intake buffers has been reached.

Referring now to FIG. 4E, the inbound arrow A(40) indicates a receipt of 40 data units that are associated with container index A. Accordingly, the received data units are stored in Buffer A, thereby bringing the stored amount of Buffer A equal to 50. Further, the cumulative amount is equal to 90 units. As shown in FIG. 4D, Buffer A now is shown in the rightmost position inside the rectangle 410, thereby indicating that Buffer A is the most recently updated intake buffer.

Referring again to FIG. 3, block 340 may include determining whether the cumulative amount of the intake buffers is greater than the total threshold. If not (“NO”), then the process 300 may continue at block 360 (described below). Otherwise, if it is determined at block 340 that the cumulative amount of the intake buffers is greater than the total threshold (“YES”), then the process 300 may continue at block 345, which may include identifying the least recently updated intake buffer. Block 350 may include generating a first container entity group (CEG) object including the data units stored in the least recently updated intake buffer. Block 355 may include writing the first CEG object from memory to persistent storage. After block 355, the process 300 may continue at block 360 (described below).

For example, referring to FIG. 4F, the inbound arrow D(20) indicates a receipt of 20 data units associated with container index D. Accordingly, the received data units are stored in Buffer D, thereby bringing the stored amount of Buffer D equal to 40. However, the cumulative amount is equal to 110 units, which exceeds the total threshold of 100 data units. Therefore, as shown in FIG. 4G, the least recently updated intake buffer (i.e., Buffer B) is evicted, and the 10 data units stored in Buffer B are included in a CEG object 430. In some implementations, the CEG object 430 may be written from memory to remote storage (e.g., from memory 115 to remote storage 190, as shown in FIG. 1).

Referring again to FIG. 3, block 360 may include determining the stored amount of each intake buffer. Block 370 may include determining whether any intake buffer has a stored amount greater than the individual threshold. If not (“NO”), the process 300 may be completed. Otherwise, if it is determined at block 370 that an intake buffer has a stored amount that is greater than the individual threshold (“YES”), the process 300 may continue at block 380, which may include generating a second CEG object including the data units stored in the intake buffer. Block 390 may include writing the second CEG object from memory to persistent storage. After block 390, the process 300 may be completed.

For example, referring to FIG. 4H, the inbound arrow A(1s) indicates a receipt of 12 data units associated with container index A. Accordingly, the received data units are stored in Buffer A. However, the cumulative amount is equal to 112 units, which exceeds the total threshold of 100 data units. Accordingly, as shown in FIG. 4I, the least recently updated intake buffer (i.e., Buffer C) is evicted, and the 10 data units stored in Buffer C are included in a CEG object 440.

However, in FIG. 4I, the stored amount of Buffer A is equal to 62 data units, which exceeds the individual threshold of 60 data units. Accordingly, as shown in FIG. 4J, the intake buffer that is exceeding the individual threshold (i.e., Buffer A) is evicted, and the contents of Buffer A are included in a CEG object 450. As such, in FIG. 4J, the cumulative amount (40) is now less than the total threshold, and no intake buffer has a stored amount that exceeds the individual threshold.

It is noted that, while FIGS. 3 and 4A-4J illustrate an example implementation, other implementations are possible. For example, while FIG. 3 shows the comparison of the cumulative amount to the total threshold (at block 340) occurring before the comparison of the stored amount of a single intake buffer to the individual threshold (at block 370), it is contemplated that the order of these comparison could be reversed, could occur simultaneously, and so forth. Further, it is contemplated that the process 300 (shown in FIG. 3) could be modified to exclude the generation of a CEG object based on the cumulative amount (i.e., without performing blocks 340-355), or to exclude the generation of a CEG object based on the stored amount of a single intake buffer (i.e., without performing blocks 370-390).

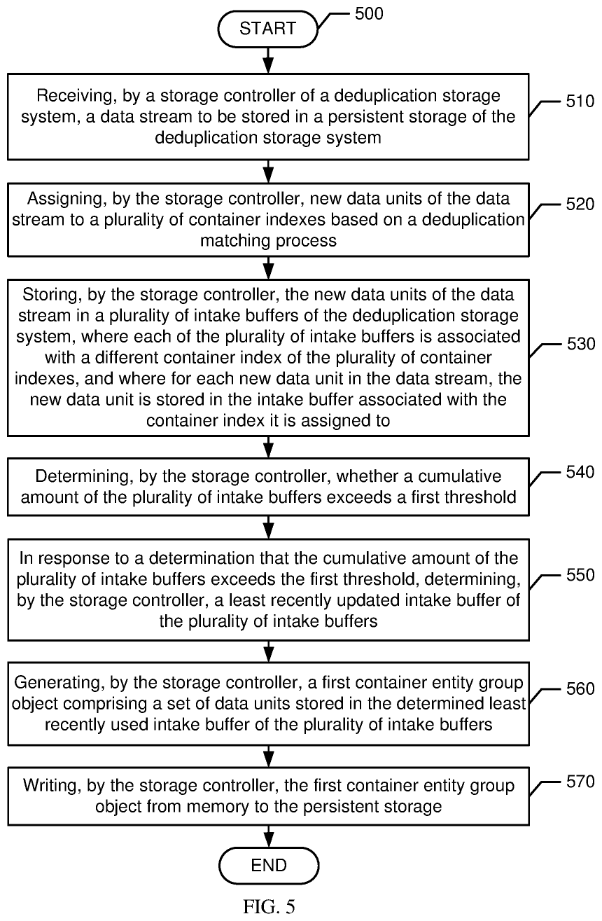

### FIG. 5—Example Process for Storing Data

FIG. 5 shows is an example process 500 for adding a new data index, in accordance with some implementations. The process 500 may be performed by a controller executing instructions (e.g., storage controller 110 shown in FIG. 1). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. For the sake of illustration, details of the process 500 are described below with reference to FIGS. 1 and 4A-4J, which show examples in accordance with some implementations. However, other implementations are also possible.

Block 510 may include receiving, by a storage controller of a deduplication storage system, a data stream to be stored in a persistent storage of the deduplication storage system. Block 520 may include assigning, by the storage controller, new data units of the data stream to a plurality of container indexes based on a deduplication matching process. Block 530 may include storing, by the storage controller, the new data units of the data stream in a plurality of intake buffers of the deduplication storage system, where each of the plurality of intake buffers is associated with a different container index of the plurality of container indexes and where for each new data unit in the data stream, the new data unit is stored in the intake buffer associated with the container index it is assigned to.

For example, referring to FIG. 1, the storage controller 110 may perform a deduplication matching process, which may include generating fingerprints for data units in a data stream, and attempting to match these fingerprints to the fingerprints included in container indexes A, B, C, and D (not shown in FIG. 1). The storage controller 110 may determine that fingerprints of ten contiguous data units in the data stream do not match the fingerprints in the container indexes A, B, C, and D, and therefore these ten data units are new data units. The storage controller 110 may determine that the ten new data units are preceded (in the data stream) by twenty data units that match to container index A, and are followed (in the data stream) by five data units that match to second container B. The storage controller 110 determines that container index A has the largest match proximity (i.e., twenty) to the new data units, and therefore assigns the ten new data units to container index A. Accordingly, the storage controller 110 stores the ten new data units in the intake buffer A that corresponds to container index A. This operation is illustrated in FIG. 4A, which shows an inbound arrow A(10) to indicate the storage of the ten new data units in the intake buffer A, which is associated with container index A.

Referring again to FIG. 5, block 540 may include determining, by the storage controller, whether a cumulative amount of the plurality of intake buffers exceeds a first threshold. Block 550 may include, in response to a determination that the cumulative amount of the plurality of intake buffers exceeds the first threshold, determining, by the storage controller, a least recently updated intake buffer of the plurality of intake buffers. Block 560 may include generating, by the storage controller, a first container entity group object comprising a set of data units stored in the determined least recently updated intake buffer of the plurality of intake buffers. Block 570 may include writing, by the storage controller, the first container entity group object from memory to the persistent storage. After block 570, the process 500 may be completed.

For example, referring to FIG. 4F, an inbound arrow D(20) indicates a receipt of 20 data units associated with container index D. Accordingly, the received data units are stored in Buffer D. However, the cumulative amount is equal to 110 units, which exceeds the total threshold of 100 data units. Therefore, as shown in FIG. 4G, the least recently used intake buffer (i.e., Buffer B) is evicted, and the 10 data units stored in Buffer B are included in a CEG object 430. In some implementations, the CEG object 430 may be written from memory to remote storage (e.g., from memory 115 to remote storage 190, as shown in FIG. 1).

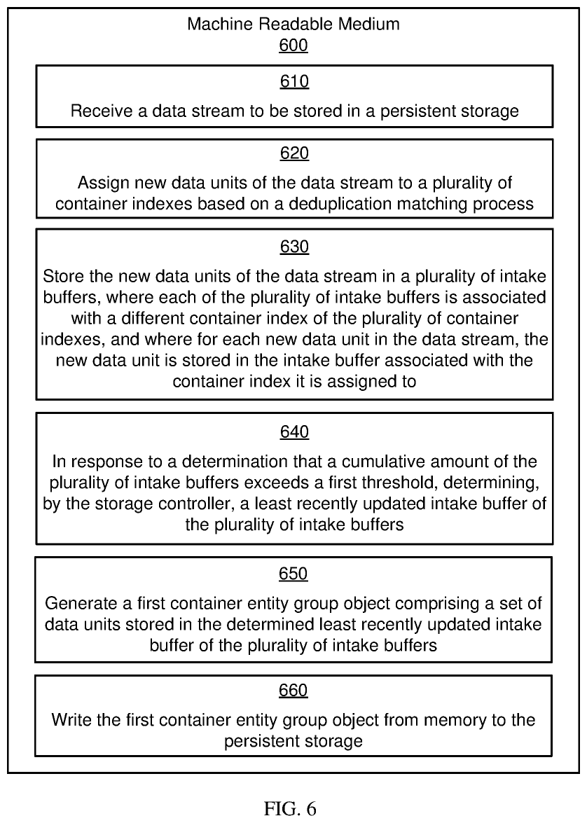

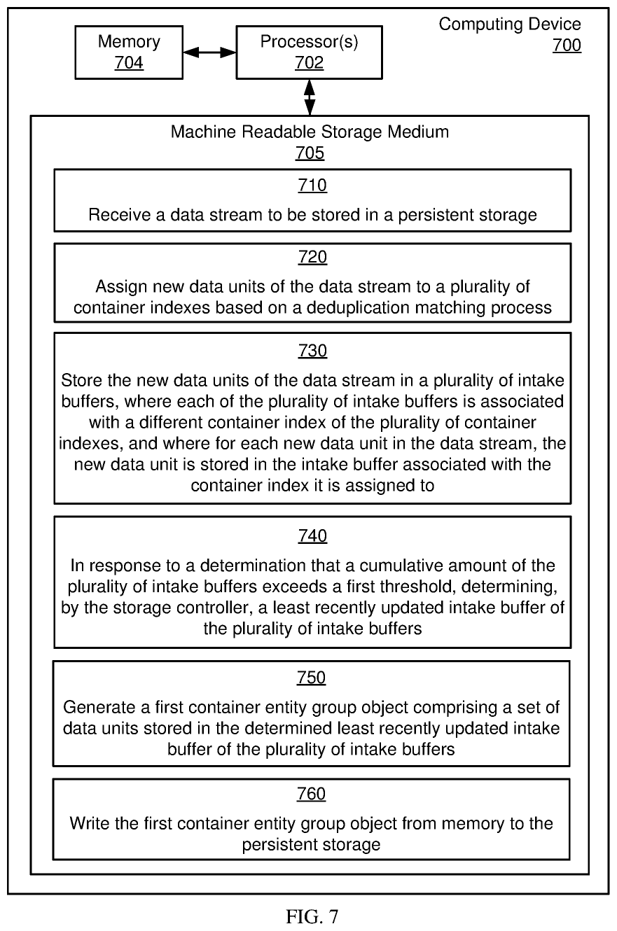

### FIG. 6—Example Machine-Readable Medium

FIG. 6 shows a machine-readable medium 600 storing instructions 610-650, in accordance with some implementations. The instructions 610-650 can be executed by a single processor, multiple processors, a single processing engine, multiple processing engines, and so forth. The machine-readable medium 600 may be a non-transitory storage medium, such as an optical, semiconductor, or magnetic storage medium.

Instruction 610 may be executed to receive a data stream to be stored in persistent storage of a deduplication storage system. Instruction 620 may be executed to assign new data units of the data stream to a plurality of container indexes based on a deduplication matching process. Instruction 630 may be executed to store the new data units of the data stream in a plurality of intake buffers of the deduplication storage system, where each of the plurality of intake buffers is associated with a different container index of the plurality of container indexes, and where for each new data unit in the data stream, the new data unit is stored in the intake buffer associated with the container index it is assigned to.

Instruction 640 may be executed to, in response to a determination that a cumulative amount of the plurality of intake buffers exceeds a first threshold, determining, by the storage controller, a least recently updated intake buffer of the plurality of intake buffers. Instruction 650 may be executed to generate a first container entity group object comprising a set of data units stored in the determined least recently updated intake buffer of the plurality of intake buffers. Instruction 660 may be executed to write the first container entity group object from memory to the persistent storage.

### FIG. 7—Example Computing Device

FIG. 7 shows a schematic diagram of an example computing device 700. In some examples, the computing device 700 may correspond generally to some or all of the storage system 100 (shown in FIG. 1). As shown, the computing device 700 may include a hardware processor 702, a memory 704, and machine-readable storage 705 including instructions 710-750. The machine-readable storage 705 may be a non-transitory medium. The instructions 710-750 may be executed by the hardware processor 702, or by a processing engine included in hardware processor 702.

Instruction 710 may be executed to receive a data stream to be stored in a persistent storage. Instruction 720 may be executed to assign new data units of the data stream to a plurality of container indexes based on a deduplication matching process. Instruction 730 may be executed to store the new data units of the data stream in a plurality of intake buffers, where each of the plurality of intake buffers is associated with a different container index of the plurality of container indexes, and where for each new data unit in the data stream, the new data unit is stored in the intake buffer associated with the container index it is assigned to.

Instruction 740 may be executed to, in response to a determination that a cumulative amount of the plurality of intake buffers exceeds a first threshold, determining, by the storage controller, a least recently updated intake buffer of the plurality of intake buffers. Instruction 750 may be executed to generate a first container entity group object comprising a set of data units stored in the determined least recently updated intake buffer of the plurality of intake buffers. Instruction 760 may be executed to write the first container entity group object from memory to the persistent storage.

In accordance with implementations described herein, a deduplication storage system may store data updates in a set of intake buffers in memory. Each intake buffer may store data updates associated with a different container index. In some implementations, the deduplication storage system may limit the maximum number of intake buffers that can be used at the same time. Further, the deduplication storage system may evict any intake buffer having a stored amount that exceeds an individual threshold. Furthermore, upon determining that the cumulative amount of the intake buffers exceeds a total threshold, the deduplication storage system may evict the least recently updated intake buffer. In some implementations, the number and size of transfers to remote storage may be controlled by adjusting one or more of the maximum number of intake buffers, the individual threshold, and the total threshold. In this manner, the financial cost associated with the transfers to remote storage may be reduced or optimized.

Note that, while FIGS. 1-7 show various examples, implementations are not limited in this regard. For example, referring to FIG. 1, it is contemplated that the storage system 100 may include additional devices and/or components, fewer components, different components, different arrangements, and so forth. In another example, it is contemplated that the functionality of the storage controller 110 described above may be included in any another engine or software of storage system 100. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A storage system comprising:
a processor;
a memory; and
a machine-readable storage storing instructions, the instructions executable by the processor to:
receive a data stream to be stored in a persistent storage;
assign new data units of the data stream to a plurality of container indexes based on a deduplication matching process;
store the new data units of the data stream in a plurality of intake buffers loaded in the memory, wherein each of the plurality of intake buffers is associated with a different container index of the plurality of container indexes, and wherein for each new data unit in the data stream, the new data unit is stored in the intake buffer associated with the container index it is assigned to;
in response to a determination that a cumulative amount of the plurality of intake buffers exceeds a first threshold, determining, by the storage controller, a least recently updated intake buffer of the plurality of intake buffers;
generate a first container entity group object comprising a set of data units stored in the determined least recently updated intake buffer of the plurality of intake buffers; and
write the first container entity group object from the memory to the persistent storage.

2. The storage system of claim 1, including instructions executable by the processor to:
determine a stored amount for a first intake buffer of the plurality of intake buffers;
in response to the determination that the stored amount for a first intake buffer exceeds the second threshold, generate a second container entity group object comprising a set of data units stored in the first intake buffer; and
write the second container entity group object from the memory to the persistent storage.

3. The storage system of claim 2, wherein the first threshold and the second threshold are configuration settings of the storage system.

4. The storage system of claim 1, wherein a maximum number of the plurality of intake buffers loaded in the memory is a configuration setting of the storage system.

5. The storage system of claim 1, including instructions executable by the processor to:
determine an order of the plurality of intake buffers loaded in the memory according to recency of use of each intake buffer.

6. The storage system of claim 1, including instructions executable by the processor to:
generate fingerprints for a plurality of data units in the data stream;
match the generated fingerprints to stored fingerprints in the plurality of container indexes;
determine a first data unit having a generated fingerprint that does not match the stored fingerprints in the plurality of container indexes;
determine, from the plurality of container indexes, a first container index having a largest match proximity with the first data unit;
assign the first data unit to the first container index;
identify an intake buffer associated with the first container index; and
store the first data unit in the intake buffer associated with the first container index.

7. The storage system of claim 1, wherein each of the plurality of intake buffers loaded in the memory is associated with a different range of locations in the data stream, and wherein at least one range of locations in the data stream is not associated with any of the plurality of intake buffers loaded in the memory.

8. The storage system of claim 1, wherein the persistent storage is a network-based storage service, and wherein the storage system is coupled to the network-based storage service via a network connection.

9. A method comprising:
receiving, by a storage controller of a deduplication storage system, a data stream to be stored in a persistent storage of the deduplication storage system;
assigning, by the storage controller, new data units of the data stream to a plurality of container indexes based on a deduplication matching process;
storing, by the storage controller, the new data units of the data stream in a plurality of intake buffers of the deduplication storage system, wherein each of the plurality of intake buffers is associated with a different container index of the plurality of container indexes, and wherein for each new data unit in the data stream, the new data unit is stored in the intake buffer associated with the container index it is assigned to;
determining, by the storage controller, whether a cumulative amount of the plurality of intake buffers exceeds a first threshold;
in response to a determination that the cumulative amount of the plurality of intake buffers exceeds the first threshold, determining, by the storage controller, a least recently updated intake buffer of the plurality of intake buffers;
generating, by the storage controller, a first container entity group object comprising a set of data units stored in the determined least recently updated intake buffer of the plurality of intake buffers; and
writing, by the storage controller, the first container entity group object from memory to the persistent storage.

10. The method of claim 9, further comprising:
determining a stored amount for a first intake buffer of the plurality of intake buffers;
in response to the determination that the stored amount for a first intake buffer exceeds the second threshold, generating a second container entity group object comprising a set of data units stored in the first intake buffer; and
writing the second container entity group object from the memory to the persistent storage.

11. The method of claim 10, wherein the first threshold and the second threshold are configuration settings of the storage system, and wherein a maximum number of the plurality of intake buffers loaded in the memory is another configuration setting of the storage system.

12. The method of claim 9, further comprising:
determining an order of the plurality of intake buffers loaded in the memory according to recency of use of each intake buffer.

13. The method of claim 9, further comprising:
generating fingerprints for a plurality of data units in the data stream;
matching the generated fingerprints to stored fingerprints in the plurality of container indexes;
determining a first data unit having a generated fingerprint that does not match the stored fingerprints in the plurality of container indexes;
determining, from the plurality of container indexes, a first container index having a largest match proximity with the first data unit;
assigning the first data unit to the first container index;
identifying an intake buffer associated with the first container index; and
storing the first data unit in the intake buffer associated with the first container index.

14. The method of claim 9, wherein the persistent storage is a network-based storage service, and wherein the storage system is coupled to the network-based storage service via a network connection.

15. A non-transitory machine-readable medium storing instructions that upon execution cause a processor to:
receive a data stream to be stored in persistent storage of a deduplication storage system;
assign new data units of the data stream to a plurality of container indexes based on a deduplication matching process;
store the new data units of the data stream in a plurality of intake buffers of the deduplication storage system, wherein each of the plurality of intake buffers is associated with a different container index of the plurality of container indexes, and wherein for each new data unit in the data stream, the new data unit is stored in the intake buffer associated with the container index it is assigned to;
in response to a determination that a cumulative amount of the plurality of intake buffers exceeds a first threshold, determining, by the storage controller, a least recently updated intake buffer of the plurality of intake buffers;
generate a first container entity group object comprising a set of data units stored in the determined least recently updated intake buffer of the plurality of intake buffers; and
write the first container entity group object from memory to the persistent storage.

16. The non-transitory machine-readable medium of claim 15, including instructions that upon execution cause the processor to:
determine a stored amount for a first intake buffer of the plurality of intake buffers;
in response to the determination that the stored amount for a first intake buffer exceeds the second threshold, generate a second container entity group object comprising a set of data units stored in the first intake buffer; and
write the second container entity group object from the memory to the persistent storage.

17. The non-transitory machine-readable medium of claim 16, wherein the first threshold and the second threshold are configuration settings of the storage system, and wherein a maximum number of the plurality of intake buffers loaded in the memory is a configuration setting of the storage system.

18. The non-transitory machine-readable medium of claim 15, including instructions that upon execution cause the processor to:
determine an order of the plurality of intake buffers loaded in the memory according to recency of use of each intake buffer.

19. The non-transitory machine-readable medium of claim 15, including instructions that upon execution cause the processor to:
generate fingerprints for a plurality of data units in the data stream;
match the generated fingerprints to stored fingerprints in the plurality of container indexes;
determine a first data unit having a generated fingerprint that does not match the stored fingerprints in the plurality of container indexes;
determine, from the plurality of container indexes, a first container index having a largest match proximity with the first data unit;
assign the first data unit to the first container index;
identify an intake buffer associated with the first container index; and
store the first data unit in the intake buffer associated with the first container index.

20. The non-transitory machine-readable medium of claim 15, wherein the persistent storage is a network-based storage service, and wherein the storage system is coupled to the network-based storage service via a network connection.
